(19) United States
(12) Patent Application Publication
(10) Pub. No.: US 2007/0299658 A1
(43) Pub. Date: Dec. 27, 2007

(54) Pitch Frequency Estimation Device, and Pich Frequency Estimation Method

(75) Inventors: Youhua Wang, Ishikawa (JP); Koji Yoshida, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/632,063

(22) PCT Filed: Jun. 23, 2005
(86) PCT No.: PCT/JP05/11533

§ 371 Date: Jan. 12, 2007

(30) Foreign Application Priority Data
Jul. 13, 2004 (JP) 2004-206387

(51) Int. Cl. G10L 11/04

(52) U.S. Cl. 704/207; 704/E13.001

(57) ABSTRACT

A pitch frequency estimation device capable of estimating a pitch frequency precisely while reducing the computational complexity required for the estimation of the pitch frequency. In this device, a spectrum extraction unit (104) extracts a pitch-harmonized spectrum from a voice spectrum. A spectral average calculation unit (106) calculates the average of the power of the pitch-harmonized spectra extracted by the spectrum extraction unit (104), in a manner to individually correspond to a plurality of pitch frequency candidates. An estimation unit estimates the pitch frequency by using the average valve calculated by the spectral average calculation unit (106).

### TECHNICAL FIELD

The present invention relates to a pitch frequency estimation apparatus and a pitch frequency estimation method, and more particular, to a pitch frequency estimation apparatus and pitch frequency estimation method for estimating a pitch frequency in the frequency domain.

### BACKGROUND ART

Typically, as a method for estimating a pitch frequency of speech in the time domain or frequency domain, autocorrelation techniques using an autocorrelation function for a speech waveform and modified correlation techniques using an autocorrelation function for a residual signal for LPC (Linear Predictive Coding) analysis are well known.

Further, when speech processing such as noise suppression and speech encoding is carried out in the frequency domain, consistency may improve when a pitch frequency is estimated in the frequency domain. As a method for estimating a pitch frequency in the frequency domain, there is a method of calculating a pitch frequency by maximizing an autocorrelation function for a frequency spectrum, and its typical equation can be expressed as equation (1) below. In this equation, pitch frequency candidate i for making autocorrelation function R(i) a maximum is an estimated pitch frequency.

$$\begin{matrix}R ( i ) = {\sum }_{k}^{} P ( k ) \cdot P ( k + i ) & {p}_{MIN} \leq i \leq {p}_{MAX}\end{matrix} \qquad ( 1 )$$

Here, k is a discrete frequency component, P(k) is power of a pitch harmonic spectrum, and P_{MIN} and P_{MAX} are minimum and maximum values respectively for pitch frequency candidate i.

However, with the pitch frequency estimation method using an autocorrelation function in the frequency domain, multiples of pitch frequencies may be calculated in error due to the influence of formants of a speech signal.

As the conventional method of carrying out pitch frequency estimation while reducing the influence of formants, there is a method, for example, disclosed in non-patent document 1. In this method, a spectrum after flattening using spectrum envelope information is used.

Non-patent Document 1: “A spectral autocorrelation method for measurement of the fundamental frequency of noise-corrupted speech”, M. Lahat, IEEE Trans. on Acoustics, Speech, and Signal Processing, vol. ASSP-35, no. 6, pp. 741-750, 1987

### DISCLOSURE OF INVENTION

Problems to be Solved by the Invention

However, with the conventional pitch frequency estimation method described above, spectrum flattening processing is performed, and therefore there is a problem that the amount of calculation required for pitch frequency estimation increases.

It is therefore an object of the present invention to provide a pitch frequency estimation apparatus and pitch frequency estimation method capable of reducing the amount of calculation required for pitch frequency estimation and accurately estimating a pitch frequency.

Means for Solving the Problem

A pitch frequency estimation apparatus of the present invention adopts a configuration having: an extraction section that extracts a pitch harmonic spectrum from a speech spectrum; an average value calculating section that calculates an average value of power of the pitch harmonic spectrum with respect to each of a plurality of pitch frequency candidates; and an estimation section that estimates a pitch frequency using the average value.

A pitch frequency estimation method of the present invention adopts a configuration having: an extraction step of extracting a pitch harmonic spectrum from a speech spectrum; an average value calculating step of calculating an average value of power of the pitch harmonic spectrum with respect to each of a plurality of pitch frequency candidates; and an estimation step of estimating a pitch frequency using the average value.

A pitch frequency estimation program of the present invention implemented on a computer, having: an extraction step of extracting a pitch harmonic spectrum from a speech spectrum; an average value calculating step of calculating an average value of power of the pitch harmonic spectrum with respect to each of a plurality of pitch frequency candidates; and an estimation step of estimating a pitch frequency using the average value.

### ADVANTAGEOUS EFFECT OF THE INVENTION

According to the present invention, it is possible to reduce the amount of calculation required for pitch frequency estimation and accurately estimate the pitch frequency.

### BRIEF DESCRIPTION OF THE DRAWINGS

FIG. 1 is a block diagram showing a configuration of a pitch frequency estimation apparatus according to one embodiment of the present invention;

FIG. 2A shows an example of an extracted speech power spectrum in one embodiment of the present invention;

FIG. 2B shows a result of multiplying an average value by an addition value under a condition that a multiplier is set at a given value in one embodiment of the present invention; and

FIG. 2C shows a result of multiplying an average value by an addition value under a condition that a multiplier is set to another value in one embodiment of the present invention.

### BEST MODE FOR CARRYING OUT THE INVENTION

An embodiment of the present invention will be described in detail below with reference to the drawings.

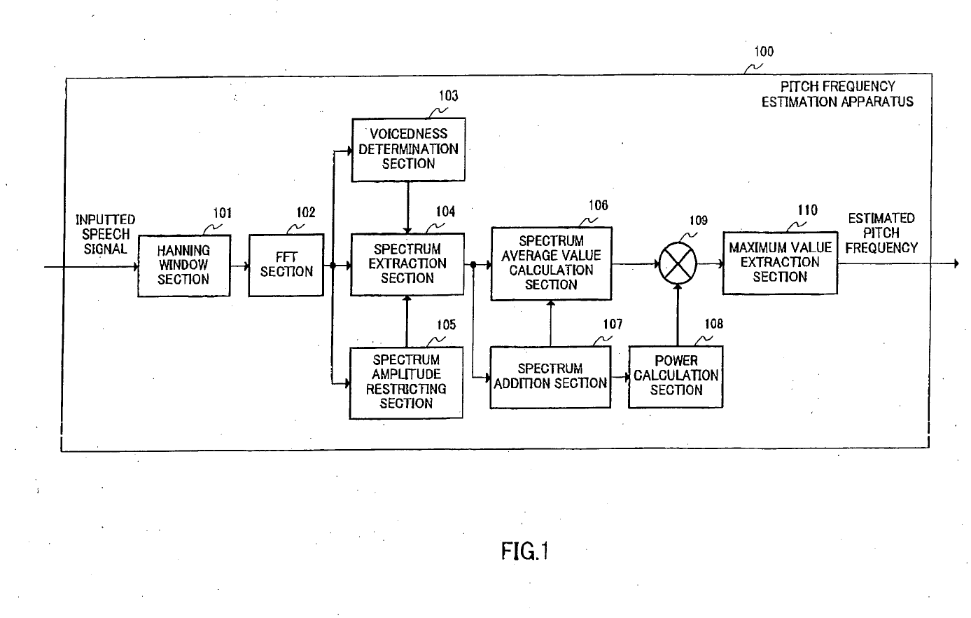

FIG. 1 is a block diagram showing a configuration of a pitch frequency estimation apparatus according to one embodiment of the present invention. Pitch frequency estimation apparatus 100 is provided with Hanning window section 101, FFT (Fast Fourier Transform) section 102, voicedness determination section 103, spectrum extraction section 104, spectrum amplitude restricting section 105, spectrum average value calculation section 106, spectrum addition section 107, power calculation section 108, multiplication section 109 and maximum value extraction section 110.

Hanning window 101 performs window processing using a Hanning window etc. on an inputted speech signal divided into frame units of predetermined time units and outputs the result to FFT section 102.

FFT section 102 performs FFT processing on frames inputted from Hanning window section 101 (i.e. a speech signal divided into frame units) and converts the speech signal to the frequency domain. As a result, a speech power spectrum is acquired. The speech signal in frame units is a speech power spectrum having predetermined frequency band. The speech power spectrum generated in this way is outputted to voicedness determination section 103, spectrum extraction section 104 and spectrum amplitude restricting section 105.

Voicedness determination section 103 determines the voicedness of the speech power spectrum from FFT section 102, that is, determines whether the original speech signal is voiced or not voiced. The result of this determination is outputted to spectrum extraction section 104.

When voicedness determination section 103 determines that the speech power spectrum does not have voicedness, spectrum extraction section 104 avoids extraction of the pitch harmonic spectrum. As a result, it is possible to reduce the amount of calculation of spectrum extraction section 104 and the overall amount of calculation of pitch frequency estimation apparatus 100.

On the other hand, when the speech power spectrum is determined to have voicedness, spectrum extraction section 104 carries out extraction of the pitch harmonic spectrum. More specifically, by extracting a peak in the speech power spectrum, the pitch harmonic spectrum is extracted.

Further, when spectrum amplitude restricting section 105 carries out amplitude restriction of the speech power spectrum, spectrum extraction section 104 restricts amplitude of the pitch harmonic spectrum by reflecting the result of this amplitude restriction in the extracted pitch harmonic spectrum. In this way, it is possible to reduce the influence of formants which may influence the accuracy of pitch frequency estimation. The pitch harmonic spectrum is outputted to spectrum average value calculation section 106 and spectrum addition section 107.

Spectrum amplitude restricting section 105 performs restriction so that the amplitude of the speech power spectrum obtained by FFT section 102 does not exceed a predetermined threshold value. The result of amplitude restriction of the speech power spectrum is outputted to spectrum extraction section 104.

Spectrum average value calculation section 106 calculates an average value of power of the pitch harmonic spectrum from spectrum extraction section 104, with respect to each of a plurality of pitch frequency candidates. Namely, in the pitch harmonic spectrum, an average value of power of frequency components that correspond to integer multiples of pitch frequency candidates is calculated, while the pitch frequency candidates are shifted from a predetermined minimum value to a predetermined maximum value. The calculated average value is then outputted to multiplication section 109.

Further, spectrum average value calculation section 106 uses a frequency component corresponding to a maximum value of power as a reference frequency at frequency band of an average value calculation target when calculating an average value.

Specifically, an average value is calculated using power at a frequency obtained by subtracting a frequency corresponding to an integer multiple of the pitch frequency candidate from the reference frequency and power at a frequency obtained by adding a frequency corresponding to an integer multiple of the pitch frequency candidate to the reference frequency. As a result, it is possible to reduce the influence of quasi-periodic characteristics of the speech and noise and reduce the accumulation of errors occurring at pitch harmonics due to pitch frequency estimation errors, so that it is possible to estimate a pitch frequency more accurately.

The average value of the power of the pitch harmonic spectrum is a value obtained by eliminating the addition value for power of the pitch harmonic spectrum described later using a specific value. As a result, spectrum average value calculation section 106 may also acquire an addition value calculated by spectrum addition section 107 and calculate an average value using the addition value.

Spectrum addition section 107 calculates an addition value for power of the pitch harmonic spectrum from spectrum extraction section 104, with respect to each of a plurality of pitch frequency candidates. Namely, at the pitch harmonic spectrum, power of frequency components corresponding to integer multiples of pitch frequency candidates is added while shifting the pitch frequency candidates from a predetermined minimum value to a predetermined maximum value. An addition value obtained through the addition of power is then outputted to power calculation section 108.

Further, spectrum addition section 107 uses a frequency component corresponding to a maximum value of power as a reference frequency at frequency band of an addition value calculation target when adding power.

Specifically, an addition value is calculated using power at a frequency obtained by subtracting a frequency corresponding to an integer multiple of a pitch frequency candidate from the reference frequency and power at a frequency obtained by adding a frequency corresponding to an integer multiple of the pitch frequency candidate to the reference frequency. As a result, it is possible to reduce the influence of quasi-periodic characteristics of the speech and noise and reduce the accumulation of errors occurring at pitch harmonics due to pitch frequency estimation errors, so that it is possible to estimate a pitch frequency more accurately.

Power calculation section 108 calculates a value of power of the addition value calculated by spectrum addition section 107. The value of the calculated power is then outputted to multiplication section 109. Further, power calculation section 108 sets a multiplier used in calculation of the power to a variable. The variable setting of the multiplier (i.e. the adjustment of the multiplier) will be described later.

The combination of multiplication section 109 and maximum value extraction section 110 configures an estimation section that estimates a pitch frequency using the average value calculated with respect to each of a plurality of pitch frequency candidates.

At the estimation section, multiplication section 109 multiplies the average value for power of the pitch harmonic spectrum by the addition value for power of the pitch harmonic spectrum, with respect to each of a plurality of pitch frequency candidates. More specifically, the power calculation result for the addition value is multiplied by the average value. The multiplication result is outputted to maximum value extraction section 110.

Maximum value extraction section 110 extracts a maximum value of the multiplication result calculated by multiplication section 109. Further, out of a plurality of pitch frequency candidates from a predetermined minimum value to a predetermined maximum value, a pitch frequency candidate for when the multiplication result becomes maximum is decided as an estimated pitch frequency, and outputted to a processing section in a latter stage (not shown).

Next, pitch frequency estimation operation of pitch frequency estimation apparatus 100 having the above configuration will be described.

First, speech power spectrum S_{F}²(k) shown in the following equation (2) is obtained by FFT section 102. Here, k indicates a discrete frequency component. H_{F} is an upper limit frequency component for pitch frequency estimation, and is, for example, H_{F}=1 [kHz]. Re{D_{F}(k)} and Im{D_{F}(k)} indicate a real part and an imaginary part of input speech spectrum D_{F}(k) after the FFT transformation.
S_{F}²(k)=Re{D_{F}(k)}²+Im{D_{F}(k)}² 0≦k≦H_{F} (2)

In equation (2), a power value for the spectrum is used, but it is also possible to use a spectrum amplitude value taking a square root in place of the power value.

Further, voicedness determination section 103 determines voicedness of speech power spectrum S_{F}² (k).

Specifically, first, sum S² (m) of speech power spectrum S_{F}² (k) of frame m and moving average value N² (m) of estimated noise spectrum power are respectively calculated using the following equations (3) and (4). Here, α is a moving average coefficient and Θ_{N} is a threshold value for determining speech or noise.

$$\begin{matrix} {S}^{2} ( m ) = {\sum }_{k = 1}^{{H}_{F}} {S}_{F}^{2} ( k ) & ( 3 ) \\ {N}^{2} ( m ) = \{ \begin{matrix}{N}^{2} ( m - 1 ) & {S}^{2} ( m ) > {Θ}_{N} \cdot {N}^{2} ( m - 1 ) \\ ( 1 - α ) \cdot {N}^{2} ( m - 1 ) + α \cdot {S}^{2} ( m ) & {S}^{2} ( m ) > {Θ}_{N} \cdot {N}^{2} ( m - 1 )\end{matrix} & ( 4 )\end{matrix}$$

Secondly, an SNR ratio of speech and noise is calculated using equation (5), and voicedness determination is carried out based on the calculation result. For example, as shown in equation (6), when the SNR ratio is larger than threshold value Θ_{V}, it is determined to be voiced, and when the SNR ratio is less than threshold value Θ_{V}, it is determined to be unvoiced. Here, the pitch frequency estimation operation will be described taking an example where it is determined to be voiced.

$$\begin{matrix}S N R = ( {S}^{2} ( m ) - {N}^{2} ( m ) ) / {N}^{2} ( m ) & ( 5 ) \\ V = \{ \begin{matrix}1 ( voiced ) & S N R > {Θ}_{V} \\ 0 ( unvoiced ) & S N R \leq {Θ}_{V}\end{matrix} & ( 6 )\end{matrix}$$

Then, at spectrum extraction section 104, by extracting a peak of speech power spectrum S_{F}² (k) using equation (7), pitch harmonic spectrum P_{F}(k) is extracted.
P_{F}(k)=S_{F}²(k) S_{F}²(k)>S_{F}²(k−1) & S_{F}²(k)>S_{F}²(k+1) (7)

At this time, taking into consideration displacement of the pitch harmonic spectrum occurring due to the influence of quasi-periodic characteristics of the speech and noise, speech power spectrum S_{F}²(k−1) and S_{F}²(k+1) adjacent to the extracted peak are extracted together with pitch harmonic spectrum P_{F}(k−1) and P_{F}(k+1), and the speech power spectrum at frequency components other than these is regarded as zero.

Further, when amplitude restriction of the speech power spectrum is carried out at spectrum amplitude restricting section 105, at spectrum extraction section 104, amplitude of the pitch harmonic spectrum P_{F}(k) is restricted by reflecting the result of this amplitude restriction in extracted pitch harmonic spectrum P_{F}(k).

Namely, extracted pitch harmonic spectrum P_{F}(k) is compared with a predetermined value. The predetermined value is a product of the average value of speech power spectrum S_{F}²(k) in frequency band H_{F} and multiplier coefficient δ, and can be obtained using equation (8). When the pitch harmonic spectrum P_{F}(k) exceeds the predetermined value, the amplitude of pitch harmonic spectrum P_{F}(k) is restricted by multiplying the amplitude of pitch harmonic spectrum P_{F}(k) by attenuation coefficients using equation (9). The attenuation coefficients can be obtained using equation (10).

$$\overline{{S}_{F}^{2}} = {\sum }_{k = 1}^{{H}_{F}} {S}_{F}^{2} ( k ) / {H}_{F} \qquad ( 8 )$$

P_{F}(k) [symbol] γ·P_{F}(k) P_{F}(k)>δ· S̅_̅{̅F̅}̅²̅ (9)
γ=δ· S̅_̅{̅F̅}̅²̅/P_{F}(k) (10)

Further, amplitude is similarly restricted using equations (11) and (12) for extracted pitch harmonic spectrum P_{F}(k−1) and P_{F}(k+1).
P_{F}(k−1) [symbol] γ·P_{F}(k−1) (11)
P_{F}(k+1) [symbol] γ·P_{F}(k+1) (12)

Average value P_{A}(i) for power of pitch harmonic spectrum P_{F}(k) is then calculated using equation (13) at spectrum average value calculating section 106.

$$\begin{matrix}{P}_{A} ( i ) = \frac{1}{N ( i )} ( {\sum }_{n = 1}^{{N}_{L} ( i )} {P}_{F} ( j - i \cdot n ) + {\sum }_{n = 1}^{{N}_{H} ( i )} {P}_{F} ( j + i \cdot n ) ) & {p}_{MIN} \leq i \leq {p}_{MAX}\end{matrix} \qquad ( 13 )$$

Here, N(i)=N_{F}/i, N_{L}(i)=j/i, and N_{H}(i)=(H_{F}−j)/i. Here, i is a pitch frequency candidate, and P_{MIN} and P_{MAX} are a minimum value and maximum value respectively of the pitch frequency candidates. Moreover, j is a frequency component corresponding to the maximum value of speech power spectrum S_{F}²(k) at frequency band H_{F}, and n is a coefficient that is an integer multiple of the pitch frequency.

Addition value P_{B}(i) for power of pitch harmonic spectrum P_{F}(k) is then calculated using equation (14) at spectrum adding section 107.

$${P}_{B} ( i ) = {\sum }_{n = 1}^{{N}_{L} ( i )} {P}_{F} ( j - i \cdot n ) + {\sum }_{n = 1}^{{N}_{H} ( i )} {P}_{F} ( j + i \cdot n ) {p}_{MIN} \leq i \leq {p}_{MAX} \qquad ( 14 )$$

Here, as can be understood by comparing equations (13) and (14), there is a relationship expressed by equation (15) between average value P_{A}(i) and addition value P_{B}(i). When spectrum addition section 107 calculates addition value P_{B}(i) using equation (14) and spectrum average value calculation section 106 calculates average value P_{A}(i) using equation (15) in place of equation (13), it is possible to further reduce the amount of calculation in pitch frequency estimation.

$${P}_{A} ( i ) = \frac{1}{N ( i )} {P}_{B} ( i ) \qquad ( 15 )$$

Then power calculating section 108 calculates the power of addition value P_{B}(i) using, for example, equation (16).
P_{C}(i)=(P_{B}(i))^{β} (16)

Multiplication section 109 multiplies average value P_{A}(i) by power calculation result P_{C}(i) using equation (17).

$${P}_{D} ( i ) = {P}_{A} ( i ) \cdot {P}_{C} ( i ) = \frac{1}{N ( i )} {( {P}_{B} ( i ) )}^{β + 1} \qquad ( 17 )$$

Maximum value extraction section 110 extracts maximum value P_{D—}max of multiplication result P_{D}(i) , and decides pitch frequency candidate p at this time as an estimated pitch frequency. Pitch frequency estimation operation is carried out in this manner.

Continuing on, conditions (referred to as “prevention conditions” in the following) for preventing the generation of half-pitch frequency errors and multiple pitch frequency errors will be described. Here, a description is now given taking examples of the case where pitch frequency estimation is carried out using only the average value of the power of the pitch harmonic spectrum (hereinafter referred to as the “first case”) and the case where pitch frequency estimation is carried out using the average value and addition value for the power of the pitch harmonic spectrum (hereinafter referred to as the “second case”).

First, prevention conditions in the first case are obtained quantitatively.

When average value P_{A}(p) for correctly estimated pitch frequency p is expressed using equation (18), average value P_{A}(p/²) for half pitch frequency p/2 can be obtained using equation (19).

$$\begin{matrix} {P}_{A} ( p ) = \frac{1}{N ( p )} {P}_{B} ( p ) & ( 18 ) \\ \begin{matrix}{P}_{A} ( p / 2 ) = \frac{1}{2 N ( p )} {P}_{B} ( p / 2 ) \\ = \frac{1}{2 N ( p )} ( {P}_{B} ( p ) + x \cdot {P}_{B} ( p ) ) \\ = \frac{1}{2 N ( p )} ( 1 + x ) \cdot {P}_{B} ( p )\end{matrix} & ( 19 )\end{matrix}$$

Here, x is a coefficient indicating the increasing power of addition value P_{B}(p) with respect to pitch frequency p when half pitch frequency p/2 is estimated. When pitch frequency is estimated from maximization of average value P_{A} alone, as can be understood from comparing equations (18) and (19), when condition P_{A}(p)>P_{A}(p/2) (i.e. condition x<1 is satisfied), it is possible to prevent the generation of half pitch frequency errors. Namely, when the amount of an increase of addition value P_{B} is less than P_{B}(p), it is possible to prevent the occurrence of half pitch frequency errors.

Further, average value P_{A}(2p) for multiple pitch frequency 2p can be obtained from equation (20).

$$\begin{matrix}{P}_{A} ( 2 p ) = \frac{1}{N ( p ) / 2} {P}_{B} ( 2 p ) \\ = \frac{1}{N ( p ) / 2} ( {P}_{B} ( p ) - y \cdot {P}_{B} ( p ) ) \\ = \frac{1}{N ( p ) / 2} ( 1 - y ) \cdot {P}_{B} ( p )\end{matrix} \qquad ( 20 )$$

Here, y is a coefficient indicating the reducing power of addition value P_{B}(p) with respect to pitch frequency p when multiple pitch frequency 2p is estimated. When pitch frequency is estimated from maximization of average value PA alone, as can be understood from comparing equations (18) and (20), when condition P_{A}(p)>P_{A}(2p) (i.e. condition y>0.5 is satisfied), it is possible to prevent the generation of multiple pitch frequency errors. Namely, when the amount of reduction of addition value P_{B} is greater than 0.5 P_{B}(p), it is possible to prevent the occurrence of multiple pitch frequency errors.

Next, prevention conditions occurring in the second case are obtained quantitatively.

When multiplier result P_{D}(i) expressed in equation (17) is obtained for half pitch frequency p/2 and multiple pitch frequency 2p, this becomes as shown in equations (21) and (22).

$$\begin{matrix}{P}_{D} ( p / 2 ) = \frac{1}{2 N ( p )} {( {P}_{B} ( p / 2 ) )}^{β + 1} = \frac{1}{2 N ( p )} {( {P}_{B} ( p ) + x \cdot {P}_{B} ( p ) )}^{β + 1} = \frac{1}{2 N ( p )} {( 1 + x )}^{β + 1} \cdot {( {P}_{B} ( p ) )}^{β + 1} & ( 21 ) \\ {P}_{D} ( 2 p ) = \frac{1}{N ( p ) / 2} {( {P}_{B} ( 2 p ) )}^{β + 1} = \frac{1}{N ( p ) / 2} {( {P}_{B} ( p ) - y \cdot {P}_{B} ( p ) )}^{β + 1} = \frac{1}{N ( p ) / 2} {( 1 - y )}^{β + 1} \cdot {( {P}_{B} ( p ) )}^{β + 1} & ( 22 )\end{matrix}$$

When pitch frequency is estimated by maximizing multiplication result P_{D}(i) expressed by equation (17) and, when condition P_{D}(p)>P_{D}(p/2) is satisfied, it is possible to prevent the occurrence of half pitch frequency errors. Further, when condition P_{D}(p)>P_{D}(2p) is satisfied, it is possible to prevent the occurrence of multiple pitch frequency errors.

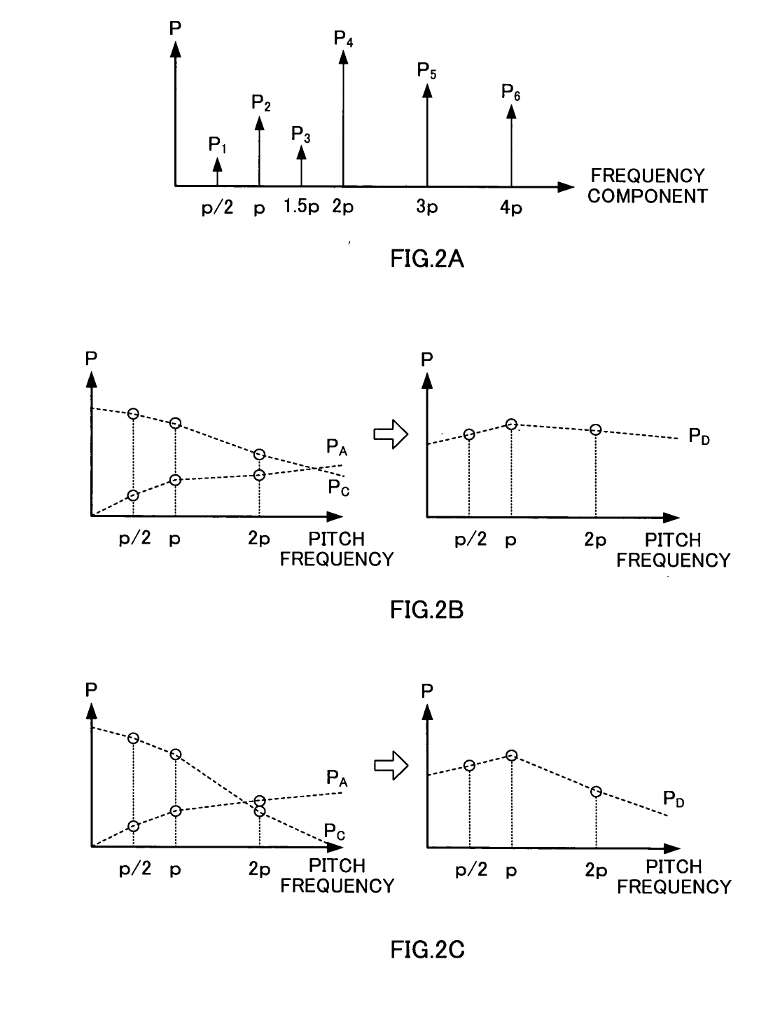

Here, an example of speech power spectrum S_{F}²(k) extracted using spectrum extraction section 104 is shown in FIG. 2A. In this example, it is assumed that a pitch harmonic spectrum is configured with the peaks shown by P2, P4, P5 and P6.

Further, FIG. 2B shows an example of the result of multiplying average value P_{A}(i) by addition value P_{B}(i) under the condition that a multiplier of the power of addition value P_{B}(i) is set to 1, and FIG. 2C shows an example of the result of multiplying average value P_{A}(i) by addition value P_{B}(i) under the condition that a multiplier of the power of addition value P_{B}(i) is set to 3.

When prevention conditions P_{D}(p)>P_{D}(p/2) for half pitch frequency errors are converted using equation (21) in the case where the multiplier is 1, x<0.414, and, in the case where the multiplier is 3, x<0.189. Further, when prevention conditions P_{D}(p)>P_{D}(2p) for multiple pitch frequency errors are converted using equation (21), in the case where the multiplier is 1, y>0.293, and, in the case where the multiplier is 3, y>0.159. Namely, it is possible to prevent the occurrence of half pitch frequency errors when the amount of an increase of addition value P_{B} is less than 0.414 P_{B}(p) in the case where the multiplier is 1, and when the amount of an increase of addition value P_{B} is less than 0.189 P_{B}(p) in the case where the multiplier is 3. Further, it is possible to prevent the occurrence of multiple pitch frequency errors when the amount of a decrease of addition value P_{B} is greater than 0.293 P_{B}(p) in the case where the multiplier is 1, and when the amount of a decrease in addition value P_{B} is greater than 0.159 P_{B}(p) in the casewhere the multiplier is 3.

Further, prevention conditions of the first case and prevention conditions of the second case are compared. As a result of this comparison, it can be understood that prevention conditions for multiple pitch frequency errors are alleviated more for the second case compared to the first case. Namely, the occurrence of multiple pitch frequency errors is mainly caused by fluctuation of the pitch harmonic spectrum amplitude value due to formants, but the probability that the prevention conditions for the multiple pitch frequency errors are no longer satisfied due to this fluctuation is lower for the second case than for the first case. Therefore, by carrying out pitch frequency estimation using the average value and addition value for power of the pitch harmonic spectrum, it is possible to reduce the influence of formants and improve the accuracy of pitch frequency estimation.

Moreover, it is also possible to freely adjust the rate of occurrence of half pitch frequency errors or the rate of occurrence of multiple pitch frequency errors by adjusting the power multiplier. For example, as described above, when the multiplier is 3, compared to the case where the multiplier is 1, half pitch frequency errors may occur more easily, but it is more difficult for multiple pitch frequency errors to occur. In other words, when the multiplier is 1, compared to the case where the multiplier is 3, multiple pitch frequency error may occur more easily, but it is more difficult for half pitch frequency errors to occur. In an actual case, it is possible to estimate a pitch frequency more accurately by selecting a multiplier according to the state of the speech and noise. For example, when pitch frequency estimation is carried out under an environment containing a great deal of noise, it is possible to reduce the rate of occurrence of half pitch frequency errors by making the multiplier a smaller value. On the other hand, it is also possible to reduce the occurrence of multiple pitch frequency errors due to the influence of formants by making the multiplier a larger value.

Here, by carrying out a simulation under the same conditions and using the same pitch harmonic spectrum, estimation error rates for pitch frequency estimation based on the autocorrelation technique shown in equation (1) and pitch frequency estimation according to this embodiment are calculated. The simulation conditions are as follows. Hanning window length is 320, FFT transformation length is 512, moving average coefficient α is 0.02, threshold value Θ_{V} is 2, multiplication coefficient δ is 6, minimum value P_{MIN} for pitch frequency candidate is 62.5 Hz, maximum value P_{MAX} for pitch frequency candidate is 390 Hz. Further, multiplier β is 3. The following table shows a calculated estimation error rate. As can be understood from the table, by selecting an appropriate multiplier, pitch frequency estimation of this embodiment is capable of reducing an estimation error rate compared to that based on autocorrelation techniques.

TABLE 1

SNR

| | 0 dB | 5 dB | 10 dB | 15 dB |
|---|---|---|---|---|
| Autocorrelation | 12.8 | 9.4 | 7.4 | 6.2 |
| Technique | | | | |
| This Embodiment | 11.7 | 5.6 | 4.7 | 4.1 |

In this way, according to this embodiment, a pitch frequency is estimated using the average value for power of the pitch harmonic spectrum and calculated with respect to each of a plurality of pitch frequency candidates. That is, pitch frequency estimation is carried out without using autocorrelation on the frequency spectrum. Therefore, spectrum flattening processing in order to reduce the influence of formants is no longer necessary, and, for example, when predetermined quantitative conditions relating to the power of the pitch harmonic spectrum are satisfied, it is possible to prevent the occurrence of half pitch frequency errors and multiple pitch frequency errors, reduce the amount of calculation required in pitch frequency estimation, and estimate a pitch frequency accurately.

Further, according to this embodiment, by multiplying the average value by addition value for power of the pitch harmonic spectrum, the average value and addition value being calculated with respect to each of a plurality of pitch frequency candidates, a pitch frequency candidate corresponding to a maximum value of the multiplication result is decided as an estimated pitch frequency. That is, pitch frequency estimation is carried out taking a multiplication value of the average value and addition value as a function. Therefore, it is possible to reduce the influence of formants without carrying out spectrum flattening processing, and improve the accuracy of pitch frequency estimation.

The pitch frequency estimation apparatus and pitch frequency estimation method of this embodiment can be applied to a speech signal processing apparatus and speech signal processing method for carrying out speech signal processing such as speech encoding and speech enhancement.

Further, the present invention may adopt various embodiments and is by no means limited to this embodiment. For example, it is also possible to implement the pitch frequency estimation method as software on a computer. Namely, a program for implementing the pitch frequency estimation method described in the above embodiment may be recorded on a recording medium such as a ROM (Read Only Memory), and the pitch frequency estimation method of the present invention may then be implemented by operating this program using a CPU (Central Processor Unit).

Each function block used to explain the above-described embodiments is typically implemented as an LSI constituted by an integrated circuit. These may be individual chips or may partially or totally contained on a single chip.

Furthermore, here, each function block is described as an LSI, but this may also be referred to as “IC”, “system LSI”, “super LSI”, “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor in which connections and settings of circuit cells within an LSI can be reconfigured is also possible.

Further, if integrated circuit technology comes out to replace LSI's as a result of the development of semiconductor technology or a derivative other technology, it is naturally also possible to carry out function block integration using this technology. Application in biotechnology is also possible.

The present application is based on Japanese Patent Application No. 2004-206387, filed on Jul. 13, 2004, the entire content of which is expressly incorporated by reference herein.

### INDUSTRIAL APPLICABILITY

The pitch frequency estimation apparatus and pitch frequency estimation method of the present invention are as applicable to an apparatus and method for carrying out speech signal processing such as speech encoding and speech enhancement.

1-11. (canceled)

12. A pitch frequency estimation apparatus comprising:
an extraction section that extracts a pitch harmonic spectrum from a speech power spectrum;
an average value calculating section that calculates an average value of power of the pitch harmonic spectrum for each of a plurality of pitch frequency candidates;
an addition value calculating section that calculates an addition value of power of the pitch harmonic spectrum for each of the plurality of pitch frequency candidates;
a power calculating section that calculates a value of power of the addition value using a multiplier with a value of 1 or above for each of the plurality of pitch frequency candidates; and
a deciding section that multiplies the average value by the value of power for each of the plurality of pitch frequency candidates, and decides a pitch frequency candidate that provides a maximum multiplication result out of the plurality of pitch frequency candidates, as an estimated pitch frequency.

13. The pitch frequency estimation apparatus according to claim 12, wherein the average value calculating section calculates for each of the plurality of pitch frequency candidates the average value at frequencies where integer multiples of pitch frequency candidates are added and subtracted, centering around a frequency providing a maximum speech power spectrum within frequency band.

14. The pitch frequency estimation apparatus according to claim 12, wherein the addition value calculating section calculates for each of the plurality of pitch frequency candidates the addition value at frequencies where integer multiples of pitch frequency candidates are added and subtracted, centering around a frequency providing a maximum speech power spectrum within frequency band.

15. The pitch frequency estimation apparatus according to claim 12, wherein the multiplier is a variable.

16. The pitch frequency estimation apparatus according to claim 12, further comprising an amplitude restricting section that restricts amplitude of the pitch harmonic spectrum.

17. The pitch frequency estimation apparatus according to claim 12, further comprising a determination section that determines a presence or absence of voicedness of the speech power spectrum,
wherein the extracting section extracts the pitch harmonic spectrum when the voicedness is present, and avoids extraction of the pitch harmonic spectrum when the voicedness is not present.

18. The pitch frequency estimation apparatus according to claim 17, wherein the determination section determines a presence or absence of voicedness of the speech power spectrum in accordance with a magnitude relationship between SNR that is a ratio between speech and noise and a threshold value.

19. A pitch frequency estimation method comprising the steps of:
extracting a pitch harmonic spectrum from a speech power spectrum;
calculating an average value and addition value of power of the pitch harmonic spectrum for each of a plurality of pitch frequency candidates;
calculating a value of power of the addition value using a multiplier with a value of 1 or above for each of the plurality of pitch frequency candidates;
multiplying the average value by the value of power for each of the plurality of pitch frequency candidates; and deciding a pitch frequency candidate that provides a maximum multiplication result out of the plurality of pitch frequency candidates, as an estimated pitch frequency.

20. A pitch frequency estimation program implemented on a computer, comprising the steps of:
extracting a pitch harmonic spectrum from a speech power spectrum;
calculating an average value of power of the pitch harmonic spectrum for each of a plurality of pitch frequency candidates;
calculating an average value of power of the pitch harmonic spectrum for each of the plurality of pitch frequency candidates;
calculating a value of power of the addition value using a multiplier with a value of 1 or above for each of the plurality of pitch frequency candidates;
multiplying the average value by the value of power for each of the plurality of pitch frequency candidates; and
deciding a pitch frequency candidate that provides a maximum multiplication result out of the plurality of pitch frequency candidates, as an estimated pitch frequency.
